(19) United States
(12) Patent Application Publication
(10) Pub. No.: US 2024/0228393 A9
(43) Pub. Date: Jul. 11, 2024

(54) SYSTEM AND METHOD OF NUTRIENT CAPTURE AND TRANSFER BY USING RECYCLABLE ALGINATE/CHITOSAN/ GLOMALIN/LIGNINCOMPOUND-INFUSED BIOLOGICALLY ACTIVATED BIOREMEDIATION UNITS

(71) Applicants: Morgan Taylor Barnes, Fort Myers, FL (US); Kelly Mahan, Fort Myers, FL (US)

(72) Inventors: Morgan Taylor Barnes, Fort Myers, FL (US); Kelly Mahan, Fort Myers, FL (US)

(21) Appl. No.: 18/048,848

(22) Filed: Oct. 23, 2022

(51) Int. Cl. C05F 11/08; C05G 5/14

(52) U.S. Cl. CPC C05F 11/08; C05G 5/14

(57) ABSTRACT

A system for nutrient remediation in a water environment using biologically active bioremediation units (BABUs), comprising a biologically active first compound of sodium alginate with chitosan, mixing a quantity of glomalin and lignin with Chlorella vulgaris to form a second mixture, mixing the first mixture with the second mixture, and spherifying the third mixture by dropping the third mixture into calcium chloride, creating a physical medium to contain the viable culture of the remediating organism called BABUs, and where the BABUs are used for nutrient remediation in a surface water environment where the surface water environment contains an excess of nutrients, waiting for nutrient capture by the BABUs, removing the nutrient rich BABUs from the water, and placing the BABUs in soil, wherein the BABUs release the nutrients to the soil.

### CROSS-REFERENCES TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates generally to a system, method, and process used for extracting nutrients from a contaminated environment. More particularly, the present invention relates to a system, method, and process of nutrient capture, transfer, and reuse by producing alginate/chitosan/soil extracted lignans and proteins (SELP) biologically active bioremediation units (BABUs), infused with live algae and capable of removing nutrient contamination from fresh surface waters and marine ecosystems.

### BACKGROUND

Surface waters, including rivers, lakes, and ponds, are subject to harmful algal “blooms” (HABs) such as blue-green algae (cyanobacteria) that are often characterized by the rapid proliferation and contamination of surface waters. Often, the presence of HABs also leads to the release of neurotoxins known as cyanotoxins. Eutrophication, the inadvertent addition of nutrients into surface waters, is often associated with fertilizer runoff. Many algal species easily assimilate these excess nutrients into blooms of algae-laden biomass. In some instances, non-toxic blooms can be harvested for nutrients and used in agricultural systems as a fertilizer. This reuse of the nutrients reduces eutrophication and recycles the nutrients back into soil amendments. Unfortunately, first maintaining then harvesting free floating bloom cultures is complicated and expensive.

Using algae to effectively bioremediate excess nitrogen and phosphorous is well established as algae multiply quickly in eutrophic conditions, thus accumulating the nutrients, including but not limited to nitrogen and phosphorus, in their biomass. However, microbial cultures tend to disperse, negating their bioremedial effectivity and making them difficult to harvest. Immobilizing algae in filters and other mediums reduces dispersal and allows easy harvesting of the accumulated biomass. However, the disposal of filters and mediums does not facilitate the recycling of valuable nitrogen and phosphorous. Designing a system that harnesses the nutrient absorbing properties of immobilized algae in a format primed for reapplication increases the sustainability of land uses associated with eutrophication.

An ideal and effective solution would be inexpensive and sustainable while providing for effectively remediating nutrients originating from agriculture and urban effluent. Ideally, the medium would keep the nutrients together microbes and be easily reintroduced to agricultural areas at a later time.

What is needed is a system, method, and process for cleaning surface waters by extracting nutrients from algal biomass in a system that allows the nutrients to be recycled for later reuse in agriculture.

### SUMMARY

A system for nutrient remediation in a surface water environment using BABUs comprising a biologically active first chemical compound, wherein the first chemical compound is created using a process of mixing a quantity of sodium alginate with chitosan in a first ratio to form a first mixture, mixing a quantity of soil extracted lignin and soil proteins with Chlorella vulgaris in a second ratio to form a second mixture, mixing the first mixture with the second mixture to form a third mixture, and spherifying the third mixture by dropping the third mixture into calcium chloride, wherein the calcium chloride is at a temperature of 28 degrees-60 degrees F. The interaction between the third mixture and the Calcium Chloride caused the third mixture to spherize forming gel-like beads with encapsulated algae. The resulting physical medium, the spherified third mixture, wherein the spherified third mixture is the quantity of BABUs, and wherein the BABUs are permeable to nutrient-rich water, and wherein the BABUs are used for nutrient remediation in a surface water environment comprising the steps of applying the BABUs to the surface water environment, wherein the surface water environment contains an excess of nutrients, waiting a period of time for nutrient capture by the BABUs, removing the nutrient rich BABUs from the surface water and placing the nutrient rich BABUs in soil, wherein the BABUs release the nutrients to the soil, and wherein the nutrients function as a soil amendment.

A method of nutrient recycling in a surface water environment, comprising applying BABUs to the surface water environment, wherein the surface water environment contains an excess of nutrients and is primed for HAB;

waiting a period of time for nutrient capture by the BABUs, removing the nutrient rich BABUs from the surface water, and placing the nutrient rich BABUs in soil, wherein the BABUs release the nutrients to the soil, and wherein the nutrients function as a soil amendment.

A process for recycling nutrients, comprising manufacturing a quantity of BABUs, identifying a nutrient-rich surface water environment, applying the BABUs to the surface water environment, wherein the surface water environment contains an excess of nutrients, waiting a period of time for nutrient capture by the BABUs, removing the nutrient rich BABUs from the surface water, and placing the nutrient rich BABUs in soil, wherein the BABUs release the nutrients to the soil, and wherein the nutrients function as a soil amendment.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a system for nutrient capture in surface waters and transferring the captured nutrients to an agricultural area in accordance with an illustrative embodiment;

FIG. 2 depicts a method for nutrient recycling using sodium alginate/chitosan/S; LP compound infused BABUs in accordance with an illustrative embodiment;

FIG. 3 depicts a method of nutrient capture and recycling using sodium alginate/chitosan/SELP in a surface water environment in accordance with an illustrative embodiment;

FIG. 4 depicts characteristics of BABUs preparation and application using a compound containing sodium alginate/chitosan/SELP in accordance with an illustrative embodiment;

FIG. 5 discloses results of a recycling process and test for extracting nutrients from an algae bloom in accordance with an illustrative embodiment;

FIG. 6 depicts characteristics of BABU structural cohesivity, viability, and reapplication strategy in accordance with an illustrative embodiment; and

FIG. 7 depicts a method of employing sodium alginate/chitosan/SELP-infused BABUs in a contaminated surface water environment in accordance with an illustrative embodiment.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact and may also include embodiments in which additional features may be positioned between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed.

Further, spatially relative terms, such as “beneath,” “below.” “lower,” “above,” “upper” and the like, may be used herein for case of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The present disclosure may be better understood, and its numerous features and advantages made apparent to those skilled in the art by referencing the accompanying drawings. The use of the same reference symbols in different drawings indicates similar or identical items.

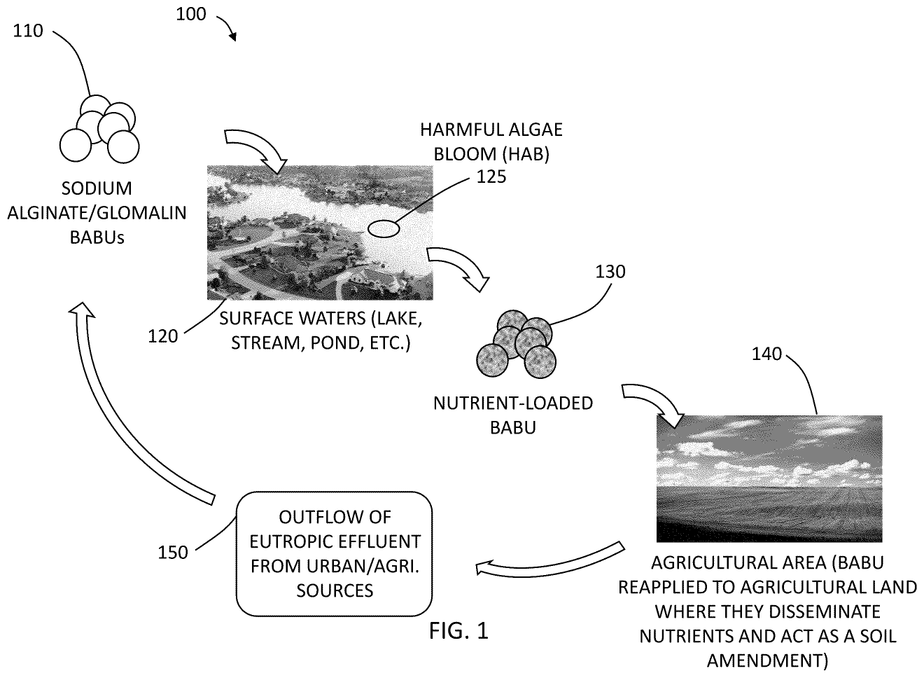

FIG. 1 depicts a system 100 for nutrient capture in surface waters and transferring the captured nutrients to an agricultural area in accordance with an illustrative embodiment. The system 100 employs BABUs 110 as disclosed in greater detail later in this paper. The BABUs 110 are applied to the surface water or waters 120, which can be a local or regional lake, river, stream, pond, retention ditch, runoff region, and the like. In at least one embodiment, the surface water 120 is polluted (contaminated) with runoff from local or distant agricultural and animal farms, ranches, residential neighborhoods, parks, golf courses, and the like where soil nutrients such as compounds containing nitrogen (N) and phosphorus (P) are used to enhance plant growth. As a side effect of adding the soil nutrients to these areas, runoff of excess nutrients often collects in surface waters, such as surface water 120 as described herein. As a result of nutrient collection in the surface water 120, HABs 125 can be formed.

The HABs 125 can be one or more of many algal species. Each HAB 125 culture can easily assimilate nutrients into blooms of biomass which can cause environmental harm. Although, non-toxic, HABs 125 could be harvested and reapplied to soils as a nutrient amendment, harvesting is often complex and expensive. However, if specialized hyperaccumulating algae could be harnessed in place, then the nutrients could be removed before initiating an HAB 125. Furthermore, immobilized algae could be re-applied as a fertilizer if the immobilization polymer enhanced soil quality upon application 140.

Sodium alginate/chitosan BABUs 110 were selected as an immobilization medium because alginate and chitosan have historically been used as a soil amendment. Over time however, the BABUs 110 lose cohesively, resulting in leaching of the nutrients back into the surface water. Cohesivity is defined as the act or state of sticking together tightly. According to some embodiments, to overcome the loss of cohesivity so that the BABUs 110 remains effective, an additional set of soil extracted proteins and carbohydrates (simplified as glomalin/lignin or SELP) is added to the sodium alginate in a specific ratio. According to some embodiments, the additive ratio can be from 0-100%. In a preferred embodiment, the ratio of 25:25:50 (SELP/chitosan/sodium alginate) has proven effective.

Glomalin is a persistent organic soil protein used to bolster the structure antiquary integrity of the BABUs 110 without negatively impacting their potential for reapplication and reuse. Sodium alginate/chitosan+SELP Chlorella v. infused BABUs 110 are constructed from solutions containing 50% sodium alginate, 25% chitosan, and 25% SELP/Chlorella v. According to some embodiments, the SELP includes Chlorella vulgaris at ratios from of 0%-100% as compared to sodium alginate/chitosan.

One preferred embodiment is a sodium alginate/chitosan/glomalin/lignin ratio of 25/25+25/25 glomalin/lignin+Chlorella v. that worked well in trials. During laboratory tests, using a compound consisting of a range of 40/60 to 60/40 of sodium alginate to glomalin, showed a significant drop in orthophosphate concentration and is an indicator of the clear viability that the sodium alginate/glomalin BABUs 110 compound does not impact the viability of the algal cultures. In another laboratory test, a neutral medium maintained a cohesive activity of 10 (kpa based scale 0-10 with 0 being not able to withstand any pressure and 10 being able to withstand pressure to the limits of the equipment) while the sodium alginate/chitosan+glomalin/lignin-infused BABUs 110 fluctuated between the values of 7 to 9. Although the sodium alginate/glomalin compound did not increase the cohesive strength of the BABUs 110, the quick initial absorbance of orthophosphate by the 45-5% group suggests that there is a globally driven absorber factor which achieves the desired reduction in the characteristic leaching of nutrients. In yet another laboratory test, alginate/chitosan BABUs 110 maintained a cohesivity of 10 for a period of 30 days.

The BABUs 110 are constructed from a variety of concentrations of chitosan/alginate as the main hydrogel molecules with SELP (soil extracted lignin and protein) which bolsters structural integrity and tends to absorb/bind to phosphorus and nitrogen. Different concentrations provide variations in BABU 110 cohesivity, permeability, and the natural binding of nutrients to the main structural molecules. A range of concentration greater than 0 to 100% for each of the 3 main factions (alginate, chitosan, and SELP) offers different properties and is dependent on the environmental conditions that the BABUs 110 would be exposed to. In one example, if the BABUs 110 were placed in a fast-moving storm drain, then exchanging permeability for increased structural strength (e.g., cohesivity) of the medium would be appropriate. Microorganisms used in bioremediation may be protist (algae), bacterial, or fungal. A consortiums of algae or a variety of taxons have also demonstrated that they can maintain viability and bioremedial capability.

FIG. 1 continues with placing the BABUs 110 into a surface water 125. If nutrient rich (Eutrophide) water is not remediated before it flows to the open surface water, a H-AB may occur. While the BABUs 110 are in the water, they start absorbing the nutrients in the water 125. After a period of time, which is defined as anywhere from 1 day to 10 weeks or more, the nutrient rich BABUs 130 are removed from the water 125 using any available mechanical means such as, but not limited to nets, scoops, filters, and the like. According to some embodiments, the nutrient rich BABUs 130 have the consistency of a gel or jelly-like density, thus making they easy to identify and remove from the water 125. Next, the nutrient rich BABUs 130 are moved to an urban/agricultural area 140. After being placed in soil, the nutrient rich BABUs 130 disseminate the nutrients into the soil and functions as a soil amendment by aiding in aggregate formation. Finally, there is an outflow of eutrophic effluent from the urban/agricultural area 140. Meanwhile, the now nutrient depleted BABUs 130 are removed from the urban/agricultural area 140. In some embodiments, the nutrient depleted BABUs degrade naturally into the soil and functions as a soil amendment.

The process to construct BABUs 110 is as follows:
1. Extract SELP from soil using a mild salt-based solution and cyclic heating and cooling to separate the glomalin, glomalin-related proteins, and lignin from the mineral components of the soil.
2. Use food-grade powdered chitosan to make a gelatin-like solution using distilled water.
3. Use food-grade alginate powder (e.g., sodium alginate or calcium alginate) to make a gelatin-like solution using distilled water.
4. Concentrate a microbial culture by spinning in a centrifuge. Note that the culture can be one species of algae, a mixture of algal species, or a mixture of microbial organisms. Tests have proven algae mixed with bacteria and fungi work well together. Performance depends on the job assigned to the culture.
5. Make Biologically Activated Gel Solution (BAGS): Mix chitosan and alginate solutions with extracted SELP (Soil Extracted Lignin and Proteins) and concentrated microbial culture.
6. Make BABUs 110: add BAGS dropwise into ice-cold salt solution (to include, but not limited to calcium lactate, calcium chloride, or sodium chloride depending on the alginate used). This creates gel-like spheres ideal for applications in surface waters 120. (The gel will automatically spherize into sphere- and sphere-like shapes when it hits the salt solution and will maintain the Chlorella v. cultures within the sphere.)
7. Leave BABUs 110 in the salt solution for at least several hours or up to several days to increase the stability of the BABUs 110.
8. Rinse the BABUs 110 with distilled water.
9. Place the BABUs 110 in an aqueous environment with an undesirable high nutrient concentrations or, alternatively, store the BABUs 110 in spring water.

The features of BABUs 110 include, but are not limited to:
1. Absorb nutrients from fertilizer/urban runoff.
   a. Nutrients can be absorbed from water before they can make it to a river/stream/ocean where the nutrients can trigger a HAB 125.
   b. The properties of algae to take in nutrients to increase biomass (body mass) is used in a controlled way using non-toxic algae species or micro-consortiums (mixtures of microorganism species).
   c. The replicating organisms will uptake the nutrients, but they must be suspended in a system that is able to be removed. Specifically, it is desirable that the BABUs 110 are suspended within the photic zone.
   i. The medium used to imprison the microorganisms cannot limit the ability of the algae to uptake the nutrients (viability).
   ii. Think of the vision as a contained algal bloom of non-toxic microorganisms that can be easily removed from the water once they deplete the nutrients
2. The BABUs 110 immobilization medium:
   a. Permeable to nutrient-rich water
   b. Must be able to imprison (immobilize) the algae
   c. Must be able to keep the algae alive
   d. Must be able to stay cohesive (stay in shape and do their job so that the algae are not released back into the water) for a length of time where they can absorb enough nutrients to bring nutrient levels back to natural nutrient ranges.
   e. Constructed from a material that will biodegrade naturally in soil due to normal organic decomposition.
   f. The decomposed BABU immobilization medium must act to improve the soil quality (function as a soil amendment).

According to some embodiments, BABUs 110 can be removed from the surface water and reapplied to soil as a fertilizer and amendment. Reapplication details include:
1. The immobilization medium must release the immobilized algae as it degrades through natural organic decomposition.
   a. The algae will decompose and release the nutrients into the soil as their body mass (biomass) decomposes.
   b. The immobilization medium improves the soil quality (“acts as a soil amendment”) To this end, the immobilization medium is constructed from a variety of well-researched soil stabilizers, and they are as follows.
      i. GRSF—Glomalin Related Soil Factions—Glomalin is a “sticky” protein that is well researched and helps soil to aggregate and clump. When soil is prepared for agriculture, the ability to form aggregates improves water retention and nutrient exchange, thus improving soil quality.
      ii. Lignin—Lignin is a biomolecule in the carbohydrate (sugar) family as a polysaccharide (complex sugar). It is a structural molecule that is used by plant life to help build their cell walls. In soil, high lignin concentrations are associated with high soil productivity. Said another way, the soil can grow and maintain more crops.
      iii. Chitosan—has been used as a soil amendment in agriculture as a soil stabilizer, aids in water retention, increases nutrient uptake by plants, inhibits nematodes, and stabilizes fertilizers (e.g., reduces fertilizer runoff so that the nutrients stay in place). Chitosan is a polysaccharide biopolymer that is derived from fungi or from the exoskeletons of crustaceans and can be sustainably sourced, is non-toxic, and is easily biodegraded through natural decomposition.
      iv. Alginate—(also known as alginic acid) is a structural carbohydrate or a polysaccharide biomolecule. It is derived from the cell wall of brown algae (e.g., kelp) and is often used as a stabilizer molecule in a variety of industries. In soil, it has been shown to enhance moisture retention, aid in aggregate formation, and a pH stabilizer.

Continuing with FIG. 1, cohesivity is important to this invention because it is crucial that the BABUs 110 maintain their structure once introduced into an environmental condition. The BABUs 110 must maintain their shape in order to remediate nutrients. If the BABUs 110 broke apart or dissolved, the microorganisms inside would be released into the water 125 and the entire system would fail in its objective. If the structure of the BABUs 110 breaks down, then the BABUs 110 cannot remediate nutrients that cause harmful algal blooms to proliferate. Through experimentation, it has been established that environmental conditions (such as rain, elevated temperatures and tropical storms) have no negative effect on the structure of BABUs 110 (the BABUs 110 maintain their shape and structure as well as their ability to maintain viable cultures).

As the BABUs degrade and break down, the dead microorganisms, through natural decomposition, cycle the nutrients into the soil system. As the BABUs degrade the chitosan/alginate/SELP components of the BABU function as a soil amendment as demonstrated by research.

Here are some additional details about the BABUs 110. The BABUs are constructed from a gel-like medium that can be infused with bioactive microorganisms. According to some embodiments, Chlorella vulgaris which, due to differences in metabolism, can absorb nutrients or other environmental contaminants and then sequester them or break them down. The BABUs 110 may not float. However, they can be placed into a system (like a net attached to a buoy) that allows the BABUs 110 to float in the photic zone of the water 125 to remediate nutrients. The BABUs are extracted from the water by picking up the system that they are in. Also, due to the inherent stability of the gel-like structure, they can literally be picked up in a net and transported. However, they should be transported in an aqueous solution if transported for a long period of time to conserve cohesivity (the structure of the immobilization medium) and keep them from drying out.

FIG. 1 continues with removing the nutrient-rich (contaminated) sodium alginate/glomalin BABUs 130 from the harmful algae bloom 125, thus improving the water quality of the surface water 120 and enabling improved oxygen levels and reducing undesirable nutrient levels in the area of interest. The nutrient rich BABUs 130 can be removed from the surface water 120 using booms, scoops, filters, vacuum devices, screens, and the like and are transported to an agricultural area. There, the nutrient rich BABUs 130 are reintroduced to the soil where the nutrients, to include nitrogen and phosphorus, leach back into the soil to function as fertilizer and other nutrient and plant friendly additives. Finally, once the nutrient rich BABUs 130 have leached a significant percentage of the nutrients back into the soil, they are removed from the soil and re-treated with the sodium alginate/glomalin compound.

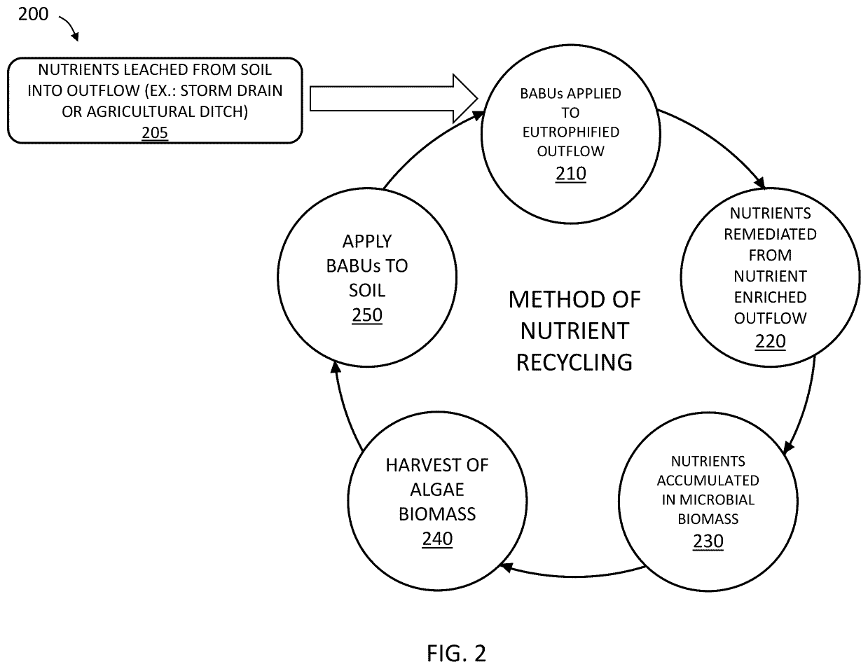

FIG. 2 depicts a method 200 for nutrient recycling using sodium alginate/chitosan/SELP compound infused BABUs 110 in accordance with an illustrative embodiment. The method 200 begins with a surface water 120 that is infused with an excess of nutrients such as fertilizer containing phosphorus (P) and nitrogen (N). Often, these excess nutrients come from runoff from nearby lawns, agricultural areas, and livestock ranches. The method 200 continues with an environment where nutrients are leached from the soil into an outflow 205. The outflow 205 can be a storm drain, an agricultural ditch, and the like. Next, BABUs 110 are applied to the eutrophified outflow 210 such as a storm drain or agricultural ditch. Next, method 200 continues with step 220 where nutrients are remediated from the nutrient enriched outflow. Next, the excess nutrients are accumulated in a microbial biomass 230, such as a HAB 125 as described in FIG. 1. Next, at step 240, the excess nutrients, now captured by the BABU's 110, are harvested. Finally. at step 250, the nutrient rich BABU's, such as BABUs 130 of FIG. 1, are transported and deposited to a soil region such as an agricultural field.

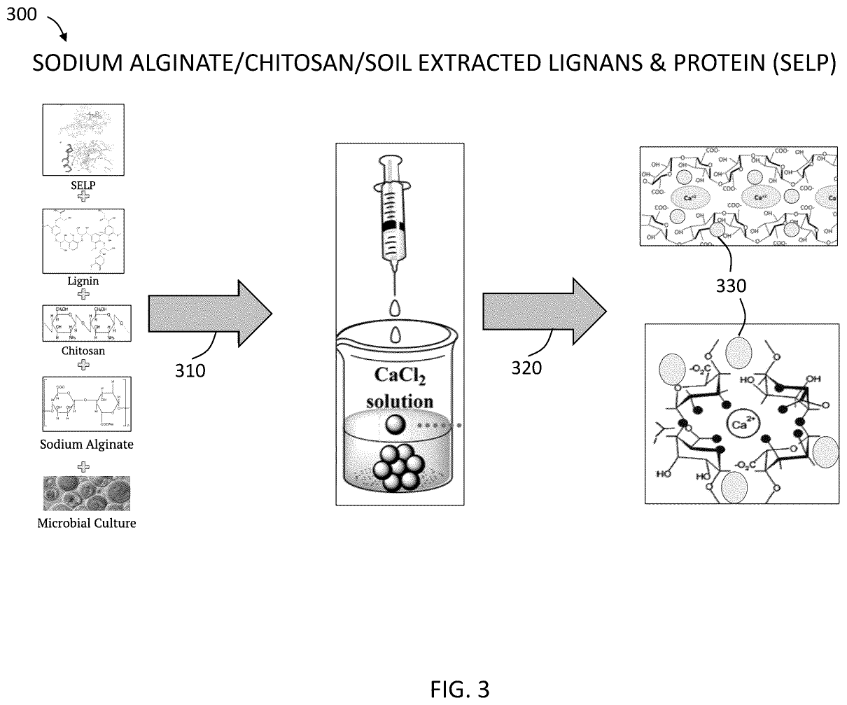

FIG. 3 depicts a method 300 of nutrient capture and recycling using sodium alginate/chitosan/SELP in a surface water environment in accordance with an illustrative embodiment. Method 300 includes combining multiple compounds together, including sodium alginate, chitosan, Chlorella v. and SELP 310. The compound is then added drop by drop into the solution. to form spherical shapes in a process called “spherification” or “spherifying” at step 320. At step 320, Spherification occurs with the associated microbial culture imbedded within the matrix.

The solution can consist of calcium chloride, a calcium lactate solution, or sodium chloride. Other materials may be used and are not limited by these examples. As a result of spherifying the gel components (alginate/chitosan) with the microbial components and the SELP, BABUs are formed in step 330, where microorganisms are immobilized within the sphere.

Sodium alginate is used in many industries including food, animal food, fertilizers, textile printing, and pharmaceuticals. Dental impression material uses alginate as its means of gelling. Food-grade alginate is an approved ingredient in processed and manufactured foods. Meanwhile, alginate absorbs water quickly, which makes it useful as an additive in dehydrated products such as slimming aids, and in the manufacture of paper and textiles. It is also used for waterproofing and fireproofing fabrics, in the food industry as a thickening agent for drinks, ice cream, cosmetics, and as a gelling agent for jellies. Sodium alginate is also mixed with soybean flour to make meat analogue.

Alginate is used as an ingredient in various pharmaceutical preparations, such as Gaviscon, in which it combines with bicarbonate to inhibit gastroesophageal reflux. Sodium alginate is used as an impression-making material in dentistry, prosthetics, life casting, and for creating positives for small-scale casting.

Sodium alginate is used in reactive dye printing and as a thickener for reactive dyes. Alginates do not react with these dyes and wash out easily. unlike starch-based thickeners. It also serves as a material for micro-encapsulation. Calcium alginate is used in different types of medical products, including skin wound dressings to promote healing and may be removed with less pain than conventional dressings. Glomalin is a glycoprotein produced abundantly on hyphae and spores of arbuscular mycorrhizal (AM) fungi in soil and in roots. Glomalin-related soil proteins (GRSPs), along with humic acid, are a significant component of soil organic matter and act to bind mineral particles together, improving soil quality. Glomalin has been investigated for its carbon and nitrogen storing properties, including as a potential method of carbon sequestration. Glomalin is hypothesized to improve soil aggregate stability and decrease soil erosion. A strong correlation has been found between GRSP and soil aggregate water stability in a wide variety of soils where organic material is the main binding agent, although the mechanism is not known.

Structural Cohesivity, Nutrient Remediation Ability, and Reapplication Viability are important features that are attractive to nutrient remediation. Many algal species easily assimilate nutrients into “blooms” of biomass which could, ideally, be harvested for nutrient application to agricultural systems. Unfortunately, maintaining, then harvesting, free-floating cultures is complicated and expensive. However, immobilizing the algae would both allow strategic placement of the culture and facilitate the harvesting of biomass.

Sodium alginate and chitosan were selected for an immobilization medium because chitosan and alginate have been used historically as a soil amendment. Unfortunately, Sphered sodium alginate and chitosan beads, lose cohesivity over time, leaching nutrients back into the system. SELP, a combination of persistent organic soil proteins and lignins, was used to bolster the structural integrity of the Sphered sodium alginate and chitosan beads without negatively impacting the potential for reapplication. Lignin is a biomolecule in the carbohydrate (sugar) family as a polysaccharide (complex sugar). It is a structural molecule that is used by plants to help build their cell walls. In soil, high lignin concentrations are associated with high soil productivity (the soil can grow and maintain more crops)

In testing, compound-infused polymer BABUs were constructed from solutions containing 50% sodium alginate and 50% glomalin/Chlorella vulgaris at ratios of 0/0%, 0/50%, 10/40%, 25/25%, and 45/5%. Thirty BABUs were placed in each flask of nutrient solution. Orthophosphate concentrations and bead structure data were collected every 3 days. All glomalin groups displayed a significant drop in orthophosphate concentration (an indicator of Chlorella viability) compared to the control, suggesting that the glomalin/alginate complex did not impact the viability of the algal cultures. The sphered sodium alginate and chitosan beads lacking glomalin maintained a cohesivity of 10 while the glomalin infused BABUs fluctuated between values of 7 and 9. Although the glomalin complex did not increase the cohesive strength of the BABUs, the quick initial absorbance of orthophosphate by the 45/5% group suggests that there is a glomalin driven absorption factor which may achieve the desired reduction in the characteristic leaching of nutrients.

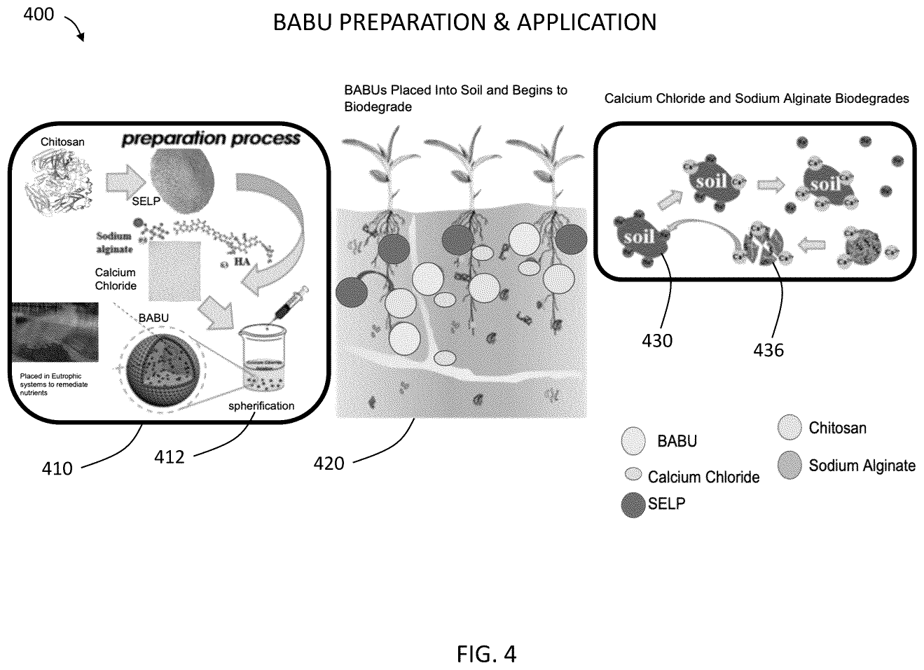

FIG. 4 depicts characteristics of Biologically Active Bioremediation Units (BABUs) preparation and application 400 using a compound containing sodium alginate/chitosan/SELP in accordance with an illustrative embodiment. The BABUs preparation 400 includes the steps of placing the BABUs into a nutrient laden (Eutrophide) outflow 410. Next, the nutrients accumulate in the biomass 420. Next, the BABUs are removed from the surface water and are deposited into soil at step 430. Finally, at step 436, the BABUs degrade through decomposition, and components amend the mineral and biological components of the soil.

The process to prepare BABUs includes:
Extract Glomalin from soil using 50 mM sodium Citrate solution
Autoclave for 90 minutes @ 121° C.
Prepare 2% Sodium Alginate, and 3% CaCl Solutions
Prepare BABUs
Chill CaCl solution to 4° C.
Mix Alginate/Chlorella/Glomalin soln. (% A/% C/% G)
100% A
50% A/10% C/40% G
50% A/25% C/25% G
50% A/40% C/10% G
50% A/50% C/00% G
Glass BABUs
Using 5 mL Syringe expel alginate solution dropwise into CaCl solution.
Place 50 BABUs into 7 beakers with 500 mL of nutrient solution for groups 1-6
Remove 10 mL every 3 days for analysis
Test 3 BABUs every week using penetrometer.
At 6 weeks, remove BABUs.
Place Soil 1 and 2 in 3 beakers each from group 1-6
Track Germination and growth rate
Submit soil to lab for soil quality and nutrient analysis

The phase I series of experiments was designed to establish the feasibility of a glomalin/alginate complex in the immobilization of bioremedial algal cultures and to determine if glomalin had a positive impact on the cohesivity of the compound-infused polymer BABUs. Viability. measured by the rate of nutrient uptake by C. vulgaris was not, observably, impacted by the introduction of glomalin. No statistically significant difference was observed in the initial cohesivity data, however a better means to determine cohesivity would be necessary to establish if the introduction of glomalin conferred a structural advantage.

Phase II is designed to better test the parameters explored in phase I of experimentation. A penetrometer was used to determine the cohesivity of the bead. Sample analysis determined Nitrate concentrations and total phosphorous. The viability of reapplication was assessed through the germination and growth rate of seeds, dry biomass and through soil quality analysis.

Inoculating sodium alginate BABUs with bioremedial algal cultures has been an effective format for immobilization. The BABUs maintain the viability of the culture, may be placed at a strategic low point, and facilitate the harvesting of the resulting biomass. Alginate has been used as a soil amendment aiding in the development of soil structure. Therefore, alginate BABUs loaded with nutrient rich algae is a superior amendment facilitating aggregate development and reapplying nutrients lost from the system in runoff.

When submerged, sodium alginate BABUs lose cohesivity leaching nutrients back into the system then dissolving. Although the time till leaching varies with pH, salinity, temperature, and other factors, maximizing the time that sodium alginate can spend in a system would increase the economic feasibility of installation.

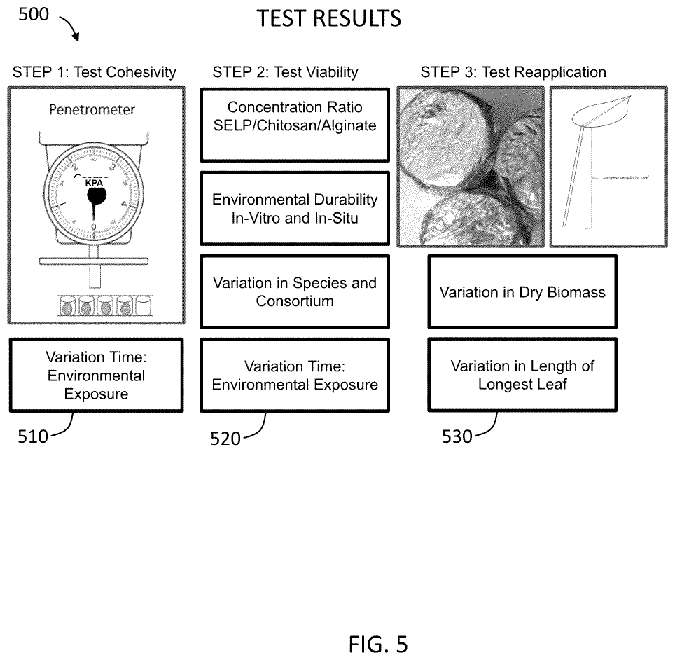

FIG. 5 discloses test results of a recycling process and test 500 for extracting nutrients from an algal bloom in accordance with an illustrative embodiment. If the BABU degrade in the surface water, they will release the nutrients back into the water and will not be able to be harvested. The test results Cohesivity tests 510 that includes testing the cohesive strength over time under various environmental conditions and with different material concentrations. Next, viability tests 520 tested the culture's ability to remediate nutrients at different material concentrations, under various environmental conditions, using different species/consortium, and over time. Finally, reapplication tests 530 tested reapplication using crop dry biomass and plant growth.

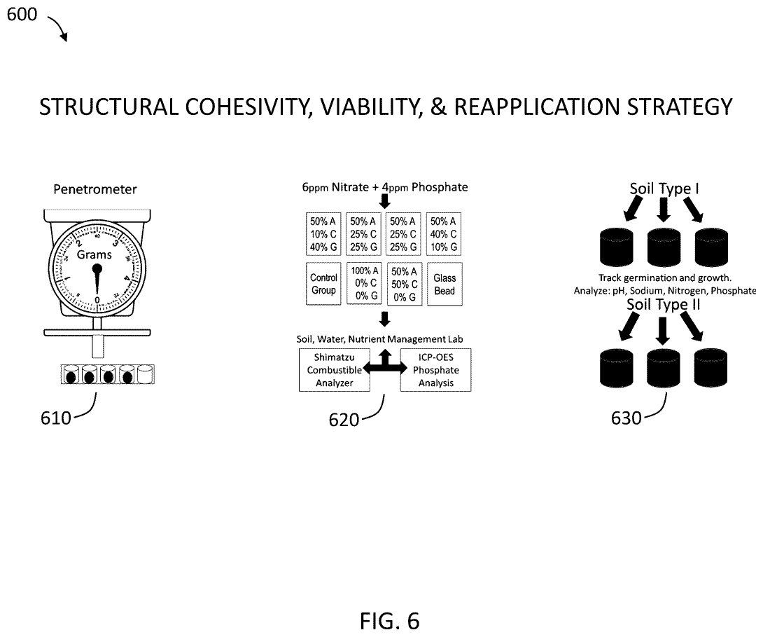

FIG. 6 depicts characteristics of BABU structural cohesivity, viability, and reapplication strategy 600 in accordance with an illustrative embodiment. In FIG. 6, a penetrometer 610 was used, as well as measurements of nitrate and phosphate concentrations 620 using a soil, water, and nutrients measurement lab. Finally, soil types 630 were used in the tests to verify the application and degradation of nutrient rich BABUs under various conditions.

Here is a partial list of prior research related to the processes and methods disclosed in this paper:
2019: Nitrifying bacteria were explored as a bio-remedial organism. The nitrifying bacteria remediated fifty percent of the nutrient solution over two weeks. However, there was a substantial ammonium waste product which suggested that this was not a viable option.
2020: Chlorella Vulgaris infused Sodium Alginate BABUs were suggested as an effective strategy to return hypereutrophic systems to natural nutrient levels. Determining if these bio-active bioremediation units (BABUs) would be able to function in synthetic weather conditions was explored. The BABU remediated 89% of the nutrient solution in all groups.
2021: Do BABUs maintain viability in actual open water systems?

The purpose is to explore the long-term viability of BABUs in environmental conditions which would be necessary in commercial applications. Problem: do environmental variables impact the long-term cohesivity and bioremediation viability of Chlorella vulgaris activated sodium alginate BABUs. Hypothesis: in-situ environmental conditions will impact Chlorella vulgaris activated sodium alginate BABUs by decreasing their penetrometer score (indicating reduced cohesiveness between cross-polymer linkages) and reduced bioremedial capabilities over time. Null hypothesis: environmental impacts will not alter the viability of immobilized bio-remediable organisms.

However, immobilizing the algae would both allow strategic placement of the culture and facilitate the harvesting of biomass. Sphered sodium alginate and chitosan beads were selected for an immobilization medium because alginate and chitosan has been used historically as a soil amendment. Unfortunately, sphered sodium alginate and chitosan beads, alone, lose cohesivity over time, leaching nutrients back into the system.

Glomalin, a persistent organic soil protein, was used to bolster the structural integrity of the sphered sodium alginate and chitosan beads without negatively impacting the potential for reapplication. Compound-infused polymer BABUs were constructed from solutions containing 50% sodium alginate and 50% glomalin/Chlorella vulgaris at ratios of 0/0%, 0/50%, 10/40%, 25/25%, and 45/5%. Thirty BABUs were placed in each flask of nutrient solution. Orthophosphate concentrations and bead structure data were collected every 3 days. All glomalin groups displayed a significant drop in orthophosphate concentration (an indicator of Chlorella viability) compared to the control, suggesting that the glomalin/alginate complex did not impact the viability of the algal cultures.

Methodology: to determine the viability of the BABUs in commercial applications, their bioremediation ability and cohesiveness were measured in environmental conditions. Initial experiments assessed three synthetic eutrophic environments: stirring (water currents), aeration (wave action), and elevated temperatures against normal laboratory conditions. For each environmental condition, there were three Erlenmeyer flasks. Each flask had 50 BABUs filled with 50 mL of nutrient solution. A negative control group (glass BABUs) and a positive control group (sodium alginate BABUs without bio-activation) were used, in conjunction with each environmental variable, to determine if there was a statistically significant difference in the remediation or cohesivity of the bio-active groups. The cohesivity of the BABUs was tested by using a penetrometer to determine the kPa withstood until structural collapse. Analysis of penetrometer pressure (kPa) and the reduction of orthophosphate and nitrate (ppm) demonstrated that there is no significant difference between the laboratory and synthetic environments.

The BABUs were distributed in a school's freshwater retention pond. The viability and cohesivity were measured for 2 months to determine durability. Each week, 50 BABUs were extracted from the pond and were immersed in a nutrient solution. After one week's immersion, nutrient remediation and cohesivity were assessed using the same methodology as the initial experiments. The in-situ data was compared to in-vitro measurements to determine if in-situ environmental variables impact the long-term application of this bioremediation strategy. The data was compared throughout the 8 weeks to determine if their penetrometer score decreased (indicating reduced cohesiveness between cross-polymer linkages). There was no statistically significant difference over the 2-month period in nutrient remediation or cohesivity.

In the in-vitro environment there was no statistically significant difference between the BABUs viability in the control group compared to the experimental groups. This indicated that the in-vitro environmental variables did not impact the BABUs viability. The BABUs remediate 89% of the nutrients after one week immersion in all groups. The BABU remediated eutrophic nutrient systems to natural levels for an undeveloped system in all groups.

There was no statistically significant difference between the positive control of the sodium alginate medium and the negative control of the glass BABUs. This data shows that the sodium alginate medium is not effective at remediating nutrients. However, there was a statistically significant difference between the independent variable of BABUs and the negative control of glass BABUs. Chlorella vulgaris infused sodium alginate BABUs were suggested as an effective strategy to return hypereutrophic systems to natural nutrient levels.

The data from the cohesivity test showed no statistically significant difference between week zero and week 8 indicating that the introduction of in situ environments did not reduce cohesiveness between cross-polymer linkages and bioremedial capabilities over time. In week three tropical storm ETA hit Southwest Florida twice in one week. The tropical storm made landfall in Fort Myers on November 11th. Eta had winds of 50 mph then moved at 13 miles an hour according to the National Hurricane Center. The data shows there was no statistically significant difference between the week three and other weeks indicating that even harsh environmental conditions do not decrease the cohesivity of the BABUs.

The data from experimentation support that there were no statistically significant differences in the BABUs viability in in situ environments in both orthophosphate and nitrate groups there is no statistically significant difference between week one and week 8 indicating that the introduced in situ environments did not impact the bioremedial capabilities of the BABUs.

In the initial experiment there was a statistically significant difference between the controls and the experimental groups. However, there was no statistically significant difference between the groups exposed to different environmental conditions. This suggests that The BABUs were equally effective remediating nutrients across a range of synthetically produced environmental conditions. In the in-situ environment, an ANOVA test analyzing the difference in viability between the groups generated a p-value of 0.227966 for nitrate and 0.468 for the orthophosphate depletion. A penetrometer was used to determine if the BABUs maintain their cohesivity over time by measuring the Pa withstood until structural collapse. An ANOVA was used to compare the cohesivity of the in-situ conditions operating a p-value of 0.1740. As all P values exceeded the alpha value of 0.05, we fail to reject the null hypothesis; “environmentally impacts will not decrease the effectivity of immobilized bioremedial organisms”. Since there was no statistically significant difference in the viability and cohesivity of the BABUs in in vitro compared to in situ conditions, the data suggests that the introduced environmental variables did not impact the viability or cohesivity of the BABUs over two months.

Conclusions include all p-values exceeded the alpha value of 0.05 we failed to reject the null hypothesis, “Environmental impacts will not decrease the effectivity of immobilized bio remedial organisms”. Since there was no statistically significant difference in the viability and cohesivity of the BABU in vitro compared to the in-situ conditions, the data suggests that the null hypothesis of introduced environmental variables did not impact the viability or cohesivity of the BABUs over two months was accepted therefore my hypothesis was rejected. Therefore, this data suggests that the BABUs will be effective on a large-scale project like Lake Okeechobee. A t-test between Chlorella vulgaris and positive control sodium alginate BABUs groups gave Aa p-value of 0 indicating that it is not likely that the difference between the groups was due to random chance. Therefore I am 100% confident that the results were due to the BABUs and not another variable throughout our experimentation tropical storm Eta unexpectedly introduce a harsh environmental variable to my study however there was no statistically significant difference between this time period compared to the rest of the study this indicates that the BABUs can withstand even harsh environmental variables are controlled events do not impact the data of the study through a comparative analysis of the BABUs bio remediation capability it was determined that there was no statistically significant difference between remediation in institute environments and in vitro environments the BABUs remediated 89% of the nutrients in both environments indicating that the null hypothesis was failed to be rejected. The data did not vary throughout repetitions experiment and there was not statistically difference of the data in the eight weeks experimentation was conducted.

Chlorella vulgaris is well-known hyperaccumulation of nutrients in both bioremediation applications and water treatment. sodium alginate has been demonstrated to be an effective immobilization medium for biological active molecules maintaining its permeability to solutions without inhibiting the entrapped enzymes or cells.

Previous research suggests that bioactive mobilization units have short-term bio remedial capabilities therefore the success of Chlorella vulgaris infuse sodium alginate BABUs in bioremediation application was explored as an effective strategy to return hypereutrophic systems to natural nutrient levels. the BABUs have an effective re bio remedial capabilities however past immobilized mediums include chitosan had limited durability in insecure environments. therefore, this year study focused on the BABUs bio remedial capabilities in durability and situate environments unlike the immobilized medium made of chitosan and the BABUs did not have limited effectivity and in-situ environments in the cross-polymer linkages of the immobilized medium did not destabilize over the eight week experiment the viability of the baboons also did not decrease throughout the experiment unlike other published data.

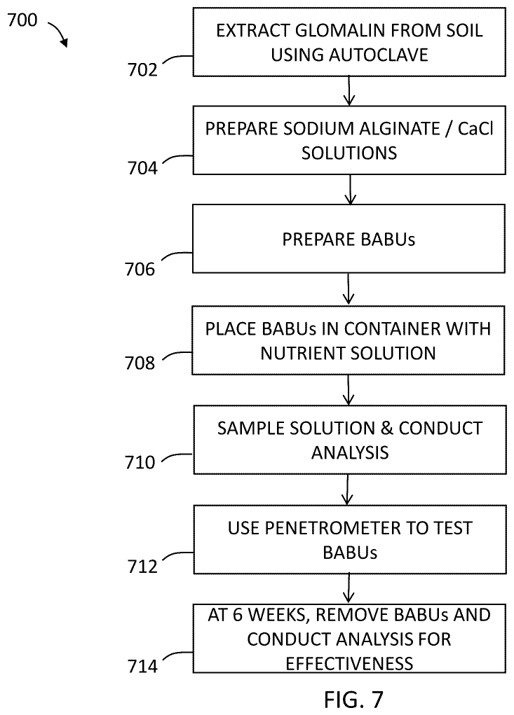

FIG. 7 depicts a method 700 of employing sodium alginate/chitosan/SELP-infused BABUs in a contaminated surface water environment in accordance with an illustrative embodiment. Method 700 includes extracting glomalin from soil using an autoclave at step 702. Next, at step 704 a sodium alginate/calcium chloride solution is made. Next, at step 706, BABUs are prepared. Next, at step 708, the BABUs are placed in a container with the nutrient solution. Next, at step 710 the solution is sampled, and one or more analysis are done. Next, at step 712, a penetrometer is used to test the BABUs. Finally, at step 714, after a period of time (e.g., 6 weeks) the BABUs are removed from the nutrients and another analysis is conducted to measure the effectiveness of the BABUs in reducing excess nutrient levels in a surface water environment,

The foregoing outlines features of several embodiments so that those of ordinary skill in the art may better understand various aspects of the present disclosure. Those of ordinary skill in the art should appreciate that they may readily use the present disclosure as a basis for designing or modifying other processes and structures for carrying out the same purposes or achieving the same advantages of various embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and 13 and/or the like generally means A or B or both A and B. Furthermore, to the extent that “includes”, “having”, “has”, “with”. or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure includes all such modifications and alterations and is limited only by the scope of the following claims. In particular regard to the various functions performed by the above-described components the terms used to describe such components are intended to correspond, unless otherwise indicated, to any component which performs the specified function of the described component (for example, a term that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A system for nutrient remediation in a surface water environment using biologically active bioremediation units (BABUs), comprising:
a biologically active first chemical compound, wherein the first chemical compound is created using a process of:
mixing a quantity of sodium alginate with chitosan in a first ratio to form a first mixture;
mixing a quantity of Soil Extracted Lignin and Proteins (SELP) with Chlorella vulgaris in a second ratio to form a second mixture;
mixing the first mixture with the second mixture to form a third mixture; and
spherifying the third mixture by dropping the third mixture into calcium chloride, wherein the calcium chloride is at a temperature of 28 degrees-60 degrees F. the spherified third mixture, wherein the spherified third mixture is a quantity of BABUs, and wherein the BABUs are permeable to nutrient-rich water, and wherein the BABUs are used for nutrient remediation in a surface water environment comprising the steps of:
applying the BABUs to the surface water environment, wherein the surface water environment contains an excess of nutrients;
waiting a period of time for nutrient capture by the BABUs;
removing the nutrient rich BABUs from the surface water; and
placing the nutrient rich BABUs in soil, wherein the BABUs release the nutrients to the soil, and wherein the nutrients and BABU medium function as a soil amendment.

2. The system of claim 1, wherein the first ratio is 2% sodium alginate through 98% chitosan to equal 100%.

3. The system of claim 1, wherein the nutrient rich BABUs degrade into the soil through organic decomposition, and wherein the degraded BABUs act to improve soil quality.

4. The system of claim 1, wherein the BABUs do not float on top of the water but are held in a photic zone in a net system.

5. The system of claim 1, further comprising BABUs contain viable cultures of microbial species/consortium, and wherein the BABUs does not harm the encapsulated algae.

6. The system of claim 1, wherein the second mixture is comprised of glomalin/lignin, and Chlorella vulgaris in a ratio that ranges between 90:10 and 1:99.

7. The system of claim 1, wherein the physical medium maintains its cohesivity in the presence of water, sunlight, algae, and nutrients, and wherein cohesivity is defined as the act or state of sticking together.

8. The system of claim 1, further comprising a bio-degradable mechanical structure that reduces to a non-hazardous material and are biodegradable.

9. The system of claim 9, wherein spherifying the third mixture comprises placing drops of the third mixture into at least one element of a set comprising a salt solution including but not limited to calcium lactate, calcium chloride solution, and sodium chloride.

10. The system of claim 1, wherein the physical medium is comprised of at least one element of a set containing glomalin-related soil factions (GRSF), lignin, chitosan, and alginate.

11. A method of nutrient recycling in a surface water environment, comprising:
applying biologically active bioremediation units (BABUs) to the surface water environment contaminated with an algae bloom, wherein the surface water environment also contains an excess of nutrients;
waiting a period of time for nutrient capture by the BABUs;
removing the nutrient rich BABUs from the surface water; and
placing the nutrient rich BABUs in soil, wherein the BABUs release the nutrients to the soil, and wherein the nutrients function as a soil amendment.

12. The method of claim 10, further comprising degrading, by the BABUs, into the soil through organic decomposition, and wherein the degraded BABUs act to improve soil quality.

13. The method of claim 10, further comprising the nutrient recycling ability of BABUs.

14. The method of claim 10, further comprising capturing the algae, by the BABUs, wherein the BABUs immobilize the algae and reduces dispersion of the algae bloom.

15. The method of claim 10, wherein the glomalin includes Chlorella vulgaris.

16. The method of claim 10, wherein the glomalin includes Chlorella vulgaris and a microbial consortium.

17. The method of claim 10, wherein the BABUs are stored in spring water prior to application in a surface water environment.

18. A process for recycling nutrients, comprising:
manufacturing a quantity of biologically active bioremediation units (BABUs);
identifying a nutrient-rich surface water environment;
applying the BABUs to the surface water environment, wherein the surface water environment contains an excess of nutrients;
waiting a period of time for nutrient capture by the BABUs;
removing the nutrient rich BABUs from the surface water; and
placing the nutrient rich BABUs in soil, wherein the BABUs release the nutrients to the soil, and wherein the nutrients function as a soil amendment.

19. The process of claim 18 wherein the BABUs are stored in spring water prior to application in a surface water environment.

20. The process of claim 18, wherein the BABUs are constructed from an immobilization medium that is composed of at least one element of a set comprising Glomalin Related Soil Factions (GRSF), lignin, chitosan, and alginate.
